(19) United States
(12) Patent Application Publication
(10) Pub. No.: US 2026/0318154 A1
(43) Pub. Date: Oct. 15, 2026

(54) LADDER SAFETY BRACE FOR USE ON DECKS HAVING SLOTS

(71) Applicants: Joseph Elwell, Merrimac, MA (US); Marc Lemieux, Derry, NH (US)

(72) Inventors: Joseph Elwell, Merrimac, MA (US); Marc Lemieux, Derry, NH (US)

(21) Appl. No.: 19/177,569

(22) Filed: Apr. 13, 2025

(51) Int. Cl. E06C 7/46

(52) U.S. Cl. CPC E06C 7/46

(57) ABSTRACT

A ladder safety device for use on a deck that can be inserted into one of the slots between the boards or planks of the deck. The ladder safety device provides a brace or a backstop that prevents the foot of a ladder on the deck from slipping or sliding along the deck, such as when the ladder is leaned against the side of a building, or against a wall. The ladder safety device reduces the likelihood of accidents while using a ladder on a deck. The device includes a plate and a bottom portion extending perpendicularly downward from the plate that can be inserted into a slot or gap in the deck, and a top portion that extends upward from the plate that serves as a backstop to prevent the foot of the ladder from slipping or sliding along the deck.

### FIELD OF THE INVENTION

This invention relates generally to ladder safety devices, and more particularly to ladder safety devices for use on decks.

### BACKGROUND OF THE INVENTION

Using a ladder on a wooden deck can present several problems, depending on the condition of the deck, the ladder, and how it's used.

For example, if the deck is wet from rain, morning dew, or snow, or if it's covered in moss or algae, the ladder's feet might slip. Polished or sealed wood can also be slick, especially with rubber ladder feet that don't grip well on smooth surfaces.

Further, decks often have railings, furniture, or other obstacles that might force one to set the ladder at a dangerous angle (too steep or too shallow). The recommended 4:1 ratio can be hard to achieve, thereby compromising stability (i.e., for every 4 feet of height, the base should be 1 foot from the wall).

Additionally, decks are often bordered by railings or adjacent walls, which can restrict where you place the ladder or make it difficult to secure both feet properly.

### SUMMARY OF THE INVENTION

The invention is a ladder safety device that increases safety while using a ladder on a deck. This ladder safety device provides a brace or a backstop that prevents the foot of a ladder from slipping along the deck when using a ladder that is leaned against the side of a building or against a wall, for example.

The ladder safety device can be inserted into one of the slots between the boards or planks of a deck. The boards or planks can be made from wood or composite, for example.

The ladder safety device includes a plate that has a bottom portion that is inserted into a slot or gap in the deck, and a top portion that extends upward to prevent the foot of the ladder from slipping or sliding along the deck.

A general aspect of the invention is a safety device for securing a ladder used on a deck having a plurality of boards spaced apart so as to create a plurality of slots, each slot extending between and along each pair of neighboring boards, a lower end of the ladder resting on the deck, and a top end of the ladder leaning against a side of a building. The safety device includes: a substantially flat plate configured to rest on at least one board of a pair of neighboring boards of a deck; a descending element perpendicularly attached along the substantially flat plate, the descending element configured to be inserted into a slot between the pair of neighboring boards; and a rising element attached along the substantially flat plate, the rising element configured to resist lateral forces due to the lower end of the ladder resting on the substantially flat plate, while the upper end of the ladder leans against the side of the building, thereby preventing the foot of the ladder from slipping.

In some embodiments, the rising element attached along the substantially flat plate extends upward in perpendicular relationship with the substantially flat plate.

In some embodiments, the rising element attached along the substantially flat plate extends upward in tilted relationship with the substantially flat plate.

In some embodiments, the rising element is attached along a center line of the substantially flat plate.

In some embodiments, the rising element is attached along an off-center line of the substantially flat plate.

In some embodiments, the rising element is attached along a rear edge of the substantially flat plate.

In some embodiments, the descending element is attached along a front edge of the substantially flat plate.

In some embodiments, the descending element is attached along a center line of the substantially flat plate.

In some embodiments, the substantially flat plate is rectangular.

In some embodiments, the rising element has a handle feature.

In some embodiments, the rising element has a hole configured to be used to grip the safety device.

In some embodiments, the descending element has a lower edge having at least one notch configured to facilitate insertion of the descending element between the pair of neighboring boards of the deck.

Another general aspect of the invention is a safety device for securing a ladder used on a deck having a plurality of boards spaced apart so as to create a plurality of slots, each slot extending between and along each pair of neighboring boards, the bottom of the ladder having two feet, the top of the ladder leaning against a side of a building. This safety device includes: a substantially flat rectangular plate configured to rest on at least one board of a pair of neighboring boards of a deck; a descending element perpendicularly attached along the substantially flat rectangular plate, the descending element configured to be inserted into a slot between the pair of neighboring boards, the descending element attached along a center line of the substantially flat rectangular plate; and a rising element perpendicularly attached along the substantially flat rectangular plate, the rising element attached along a center line of the substantially flat rectangular plate, the rising element configured to resist lateral forces due to the foot of the ladder and resting on the substantially flat rectangular plate, thereby preventing the foot of the ladder from slipping.

In some embodiments, the rising element has a hole configured to be used to grip the safety device.

In some embodiments, the descending element has a lower edge having at least one notch configured to facilitate insertion of the descending element between the pair of neighboring boards of the deck.

### BRIEF DESCRIPTION OF THE DRAWINGS

Many additional features and advantages will become apparent to those skilled in the art upon reading the following description, when considered in conjunction with the accompanying drawings, wherein:

FIG. 1 is a perspective view of a man standing on a ladder on a deck that is leaning against a wall, the ladder prevented from sliding by using an embodiment of the Ladder Safety Brace of the Invention.

FIG. 2 is a close-up perspective view of the embodiment of FIG. 1, showing how the feet of the ladder rest against the Ladder Safety Brace, and showing how the descending element of the Ladder Safety Brace is inserted into the slot between a pair of boards of the deck.

FIG. 3 is an isometric view of the embodiment of FIG. 1, showing the flat plate, the descending element perpendicularly attached along the flat plate, and the rising element attached along the flat plate, also showing the handle in the rising element, and the notches cut out of the descending element to facilitate insertion of the descending element into a slot between a pair of neighboring boards.

FIG. 4 is a bottom perspective view of the embodiment of FIG. 1, showing the underside of the flat plate and the descending element perpendicularly attached along the flat plate, also showing the notches in the descending element.

FIG. 5 is a perspective side view of the embodiment of FIG. 1, showing the handle in the rising element, and showing the notches in the descending element.

FIG. 6 is a top perspective view of the embodiment of FIG. 1, showing the flat plate, and the perpendicular rising element having a handle therein.

FIG. 7 is a perspective view of a man standing on a ladder on a deck that is leaning against a wall, the ladder prevented from sliding by using an alternate embodiment of the Ladder Safety Brace of the Invention.

FIG. 8 is a close-up perspective view of the alternate embodiment of FIG. 7, showing how the feet of the ladder rest against the alternate embodiment Ladder Safety Brace, and showing how the front edge descending element of the Ladder Safety Brace is inserted into the slot between a pair of boards of the deck.

FIG. 9 is a perspective side view of the alternate embodiment of FIG. 7, showing the front edge descending element perpendicularly attached to the front edge of the flat plate, also showing a perpendicularly attached rising element without a handle.

### DETAILED DESCRIPTION

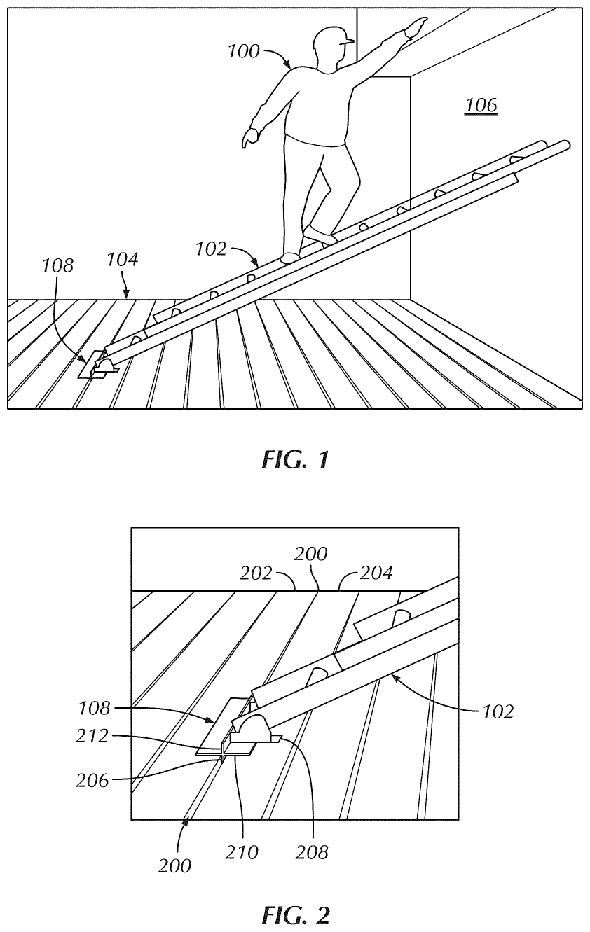

With reference to FIG. 1, a man 100 is shown standing on a ladder 102 on a deck 104. The ladder 102 is leaning against a wall 106. The ladder 102 is prevented from sliding using an embodiment 108 of the Ladder Safety Brace of the Invention.

Referring to FIG. 2, a closer view of the embodiment 108 of the Ladder Safety Brace is shown, also showing the two boards 202, 204 that together form a slot 200 in the deck 104. The embodiment 108 is inserted into the slot 200 using a descending element 206, and then the feet 208 of the ladder 102 are placed on the flat plate 210, and up against the rising element 212 of the embodiment 108.

With reference to FIG. 3, more features of the embodiment 108 are shown in further detail. The descending element 206 (shown mostly in dashed hidden line) is attached in perpendicular relationship along the flat plate 210, and the rising element 212 is attached in this embodiment 108 in perpendicular relationship along the flat plate 210. The rising element 212 has an elongated hole that serves as a grip 304 for placing and removing the embodiment 108. Further, the descending element 206 includes a lower edge 300 having a plurality of notches 302 configured to facilitate insertion of the descending element 206 between the pair of neighboring boards 202, 204 of the deck 104.

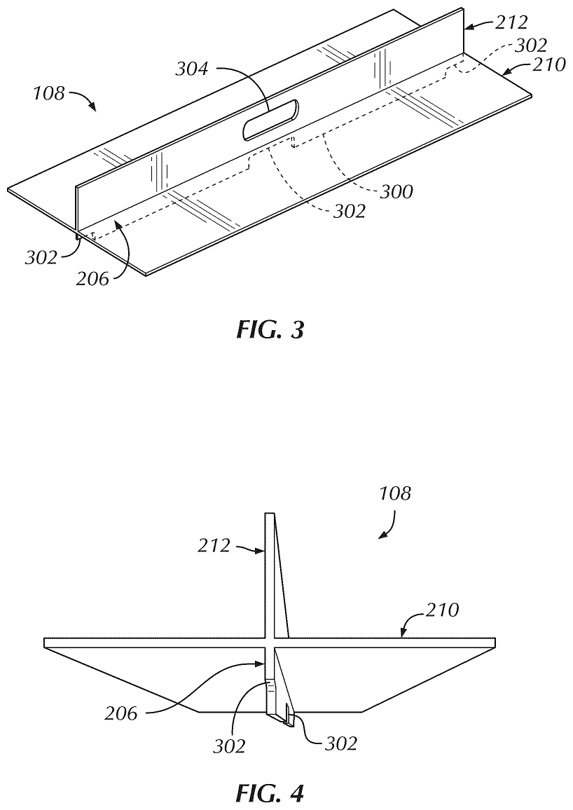

Referring to FIG. 4, the features discussed with reference to FIG. 3 are discussed again from a different viewpoint. The underside of the flat plate 210 is shown, as well as the descending element 206 and the rising element 212, both perpendicularly extending along the center of the flat plate 210. The notches 302 are also shown.

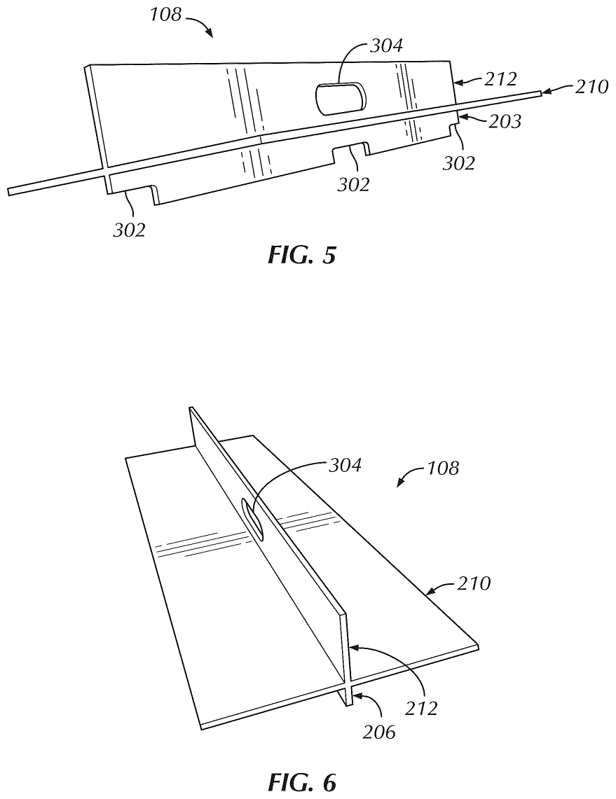

With reference to FIG. 5, the grip feature 304 and the notches 302 are more clearly seen from this perspective view of the flat plate 210, the rising element 212, and the descending element 206.

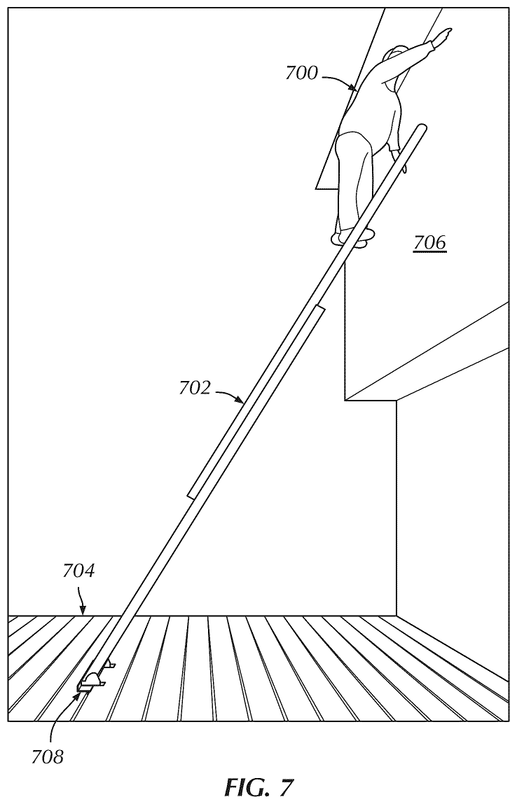

Referring to FIG. 6, another view of the embodiment 108 is shown, the grip 304 clearly seen in the rising element 212, and the descending element 206 still visible extending perpendicularly downward from the flat plate 210.

With reference to FIG. 7, a man 700 is shown standing on a ladder 702 on a deck 704. The ladder 702 is leaning against a side of a house 706. The ladder 702 is prevented from sliding across the deck 704 using an alternate embodiment 708 of the Ladder Safety Brace of the Invention.

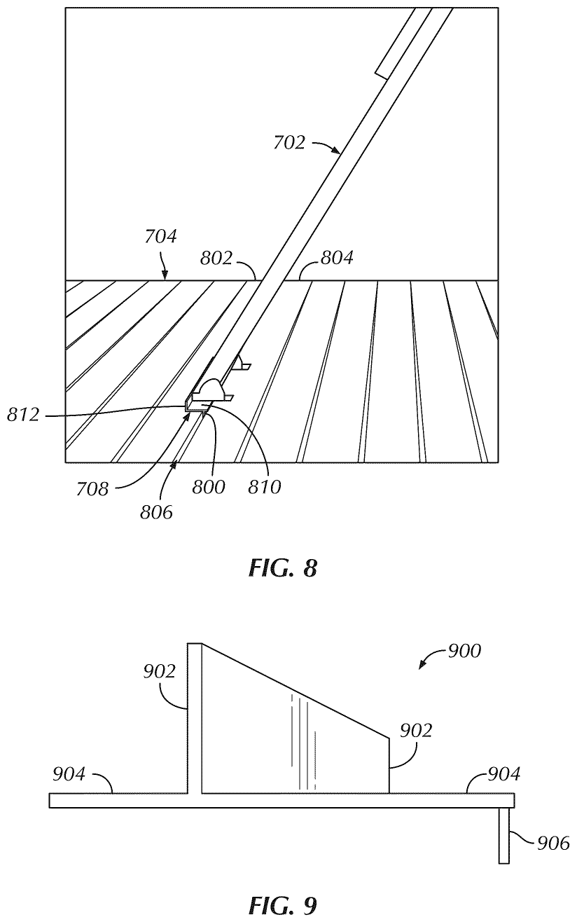

Referring to FIG. 8, a closer view of the embodiment 708 of the Ladder Safety Brace is shown, also showing the two boards 802, 804 that together form a slot 806 in the deck 704. The descending element 800 of embodiment 708 is inserted into the slot 806, and then the feet 208 of the ladder 102 are placed on the flat plate 810, and up against the rising element 812 of the embodiment 708. Note that in this embodiment 708, the rising element 812 is attached along a rear edge of the flat plate 810, and the descending element 800 is attached perpendicularly along a front edge of the flat plate 810.

With reference to FIG. 9, yet another embodiment 900 has a rising element 902 (without a handle) that is attached along an off-center line of the flat plate 904. Also, as in the embodiment 708, the descending element 906 is attached perpendicularly along a front edge of the flat plate 904.

Other modifications and implementations will occur to those skilled in the art without departing from the spirit and the scope of the invention as claimed. Accordingly, the above description is not intended to limit the invention, except as indicated in the following claims

What is claimed is:

1. A safety device for securing a ladder used on a deck having a plurality of boards spaced apart so as to create a plurality of slots, each slot extending between and along each pair of neighboring boards, a lower end of the ladder resting on the deck, and a top end of the ladder leaning against a side of a building, the safety device comprising:
a substantially flat plate configured to rest on at least one board of a pair of neighboring boards of a deck;
a descending element perpendicularly attached along the substantially flat plate, the descending element configured to be inserted into a slot between the pair of neighboring boards; and
a rising element attached along the substantially flat plate, the rising element configured to resist lateral forces due to the lower end of the ladder resting on the substantially flat plate, while the upper end of the ladder leans against the side of the building, thereby preventing the foot of the ladder from slipping.

2. The safety device of claim 1, wherein the rising element attached along the substantially flat plate extends upward in perpendicular relationship with the substantially flat plate.

3. The safety device of claim 1, wherein the rising element attached along the substantially flat plate extends upward in tilted relationship with the substantially flat plate.

4. The safety device of claim 1, wherein the rising element is attached along a center line of the substantially flat plate.

5. The safety device of claim 1, wherein the rising element is attached along an off-center line of the substantially flat plate.

6. The safety device of claim 1, wherein the rising element is attached along a rear edge of the substantially flat plate.

7. The safety device of claim 1, wherein the descending element is attached along a front edge of the substantially flat plate.

8. The safety device of claim 1, wherein the descending element is attached along a center line of the substantially flat plate.

9. The safety device of claim 1, wherein the substantially flat plate is rectangular.

10. The safety device of claim 1, wherein the rising element has a handle feature.

11. The safety device of claim 1, wherein the rising element has a hole configured to be used to grip the safety device.

12. The safety device of claim 1, wherein the descending element has a lower edge having at least one notch configured to facilitate insertion of the descending element between the pair of neighboring boards of the deck.

13. A safety device for securing a ladder used on a deck having a plurality of boards spaced apart so as to create a plurality of slots, each slot extending between and along each pair of neighboring boards, the bottom of the ladder having two feet, the top of the ladder leaning against a side of a building, the safety device comprising:
a substantially flat rectangular plate configured to rest on at least one board of a pair of neighboring boards of a deck;
a descending element perpendicularly attached along the substantially flat rectangular plate, the descending element configured to be inserted into a slot between the pair of neighboring boards, the descending element attached along a center line of the substantially flat rectangular plate; and
a rising element perpendicularly attached along the substantially flat rectangular plate, the rising element attached along a center line of the substantially flat rectangular plate, the rising element configured to resist lateral forces due to the foot of the ladder and resting on the substantially flat rectangular plate, thereby preventing the foot of the ladder from slipping.

14. The safety device of claim 13, wherein the rising element has a hole configured to be used to grip the safety device.

15. The safety device of claim 13, wherein the descending element has a lower edge having at least one notch configured to facilitate insertion of the descending element between the pair of neighboring boards of the deck.
